(19) United States
(12) Patent Application Publication
(10) Pub. No.: US 2017/0307082 A1
(43) Pub. Date: Oct. 26, 2017

(54) HYBRID PISTON PIN AND MANUFACTURING METHOD THEREOF

(71) Applicant: Hyundai Motor Company, Seoul (KR)

(72) Inventors: Sang Yoon Park, Daejeon (KR); Jeong Min Cho, Suwon-Gyeonggi-do, (KR); Chi Hoon Choi, Suwon (KR); Jong Dae Lim, Hwaseong (KR); Hee Sam Kang, Seoul (KR)

(21) Appl. No.: 15/352,463

(22) Filed: Nov. 15, 2016

(30) Foreign Application Priority Data
Apr. 25, 2016 (KR) 10-2016-0049898

(51) Int. Cl. F16J 1/16; B29C 63/00; B29C 65/48; B32B 15/18; B29C 35/02; B29C 65/00; B29C 53/04; B32B 15/08; B29K 105/08; B29K 307/04; B29L 31/00

(52) U.S. Cl. CPC F16J 1/16; B29C 53/04; B29C 63/0065; B29C 65/48; B32B 15/18; B32B 15/08; B29C 35/02; B29C 66/74283; B29C 66/721; B29K 2307/04; B29L 2031/7494; B32B 2260/021; B29K 2105/0872

(57) ABSTRACT

A hybrid piston pin and a manufacturing method thereof are provided. The hybrid piston pin includes a cylindrical pin formed of steel, a first reinforcement layer that is formed of a composite that includes reinforced fibers and a resin, having a cylindrical shape with a uniform thickness, and coupled to the interior surface of the cylindrical pin. A second reinforcement layer is formed of a composite that includes reinforced fibers having an elasticity that is less than the reinforced fibers of the first reinforcement layer. Further, a resin having a cylindrical shape with a uniform thickness is coupled to the interior surface of the first reinforcement layer.

### CROSS-REFERENCE TO RELATED APPLICATION

This application claims the priority benefit of Korean Patent Application No. 10-2016-0049898, filed on Apr. 25, 2016, in the Korean Intellectual Property Office, the disclosure of which is incorporated herein by reference.

### BACKGROUND

### 1. Field of the Invention

The present invention provides a hybrid piston pin and a manufacturing method thereof and, more particularly, to a hybrid piston pin, in which the interior surface of a cylindrical pin formed of steel is sequentially reinforced with a reinforcement layer formed of reinforced fibers having high elasticity and a reinforcement layer formed of reinforced fibers having relatively low elasticity, to provide flexural strength in a circular arrangement and flexural strength in a length direction and to achieve weight reduction.

### 2. Description of the Related Art

A piston pin formed of steel, manufactured using conventional SMC415 steel, is heavy and does not contribute to improvement in fuel efficiency when the piston pin is applied to a vehicle. Further, the piston pin does not satisfy flexural strength in a hoop direction and flexural strength in a length direction that is required for general piston pins. Therefore, manufacture of a piston pin to substitute a conventional piston pin is required. Accordingly, a hybrid piston pin formed of a composite that includes carbon fibers having a light weight and high strength is proposed.

The above information disclosed in this section is merely for enhancement of understanding of the background of the invention and therefore it may contain information that does not form the prior art that is already known in this country to a person of ordinary skill in the art.

### SUMMARY

The present invention provides a hybrid piston pin, in which the interior surface of a cylindrical pin formed of steel is sequentially reinforced with a reinforcement layer formed of reinforced fibers having a greater elasticity and a reinforcement layer formed of reinforced fibers having relatively lower elasticity to have improved flexural strength in a circular arrangement and flexural strength in a length direction and to reduce the overall weight.

In accordance with an aspect of the present invention, a hybrid piston pin may include a cylindrical pin formed of steel, a first reinforcement layer formed of a composite that includes reinforced fibers and a resin having a cylindrical shape with a substantially uniform thickness and coupled to the interior surface of the cylindrical pin and a second reinforcement layer formed of a composite that includes reinforced fibers having an elasticity less than the reinforced fibers of the first reinforcement layer and a resin having a cylindrical shape with a substantially uniform thickness and coupled to the interior surface of the first reinforcement layer.

The reinforced fibers of the first reinforcement layer and the second reinforcement layer may be carbon fibers. The reinforced fibers of the first reinforcement layer may be pitch-based carbon fibers and the reinforced fibers of the second reinforcement layer may be PAN-based carbon fibers. A thickness ratio of the cylindrical pin to the first reinforcement layer may be about 1:3˜1:6. A thickness ratio of the cylindrical pin to the second reinforcement layer may be about 1:4˜1:7.

The second reinforcement layer may include a first composite layer formed of reinforced fibers and a resin and may be disposed parallel with the length direction of the cylindrical pin. A second composite layer may be formed of reinforced fibers and a resin and may be disposed perpendicular to the length direction of the cylindrical pin. The hybrid piston pin may further include an adhesive film disposed between the cylindrical pin and the first reinforcement layer to couple the first reinforcement layer to the cylindrical pin.

In accordance with another aspect of the present invention, a manufacturing method of hybrid piston pin may include stacking a first prepreg including reinforced fibers and a resin and a second prepreg including reinforced fibers that has an elasticity less than the reinforced fibers of the first prepreg and a resin, rolling the first prepreg and the second prepreg to form an exterior surface with the first prepreg, integrally molding the rolled first prepreg and second prepreg in an oven, and attaching the molded first prepreg and second prepreg to the interior surface of a cylindrical pin formed of steel.

In some exemplary embodiments, in stacking of the first prepreg and the second prepreg, the reinforced fibers of the first prepreg and the second prepreg may be carbon fibers, the reinforced fibers of the first prepreg may be pitch-based carbon fibers, and the reinforced fibers of the second prepreg may be PAN-based carbon fibers. A thickness ratio of the cylindrical pin to the first prepreg may be about 1:3˜1:6. A thickness ratio of the cylindrical pin to the second prepreg may be about 1:4˜1:7. The manufacturing method may further include wrapping the exterior surface of the rolled first prepreg and second prepreg with an anti-resistant film, after rolling.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exemplary perspective view illustrating a hybrid piston pin in accordance with an exemplary embodiment of the present invention;

FIG. 2 is an exemplary cross-sectional view of the hybrid piston pin in accordance with an exemplary embodiment of the present invention;

FIG. 3 is an exemplary view illustrating when a first prepreg and a second prepreg are rolled and the exterior surface of the first prepreg is wrapped with a film in accordance with an exemplary embodiment of the present invention; and

FIG. 4 is an exemplary view illustrating when the first prepreg and the second prepreg are integrally molded in an oven in accordance with an exemplary embodiment of the present invention.

### DETAILED DESCRIPTION

The present invention will be described more fully hereinafter with reference to the accompanying drawings, in which exemplary embodiments of the invention are shown. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

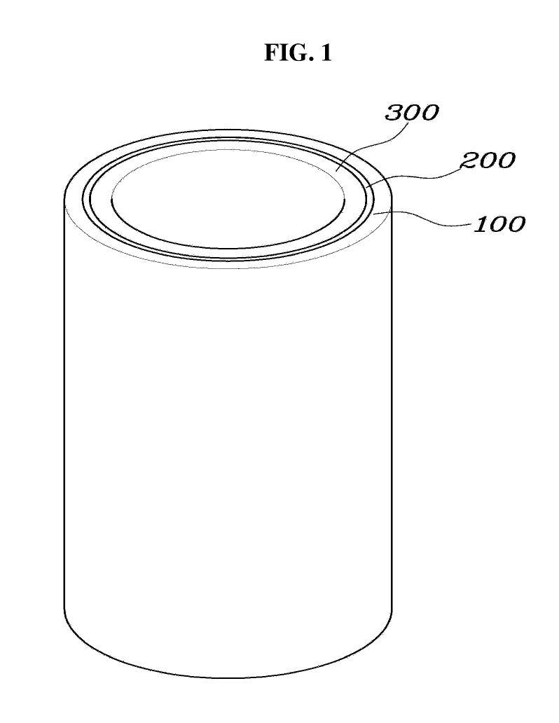

A hybrid piston pin in accordance with the present invention, as exemplarily shown in FIG. 1, may include a cylindrical pin 100 formed of steel, a first reinforcement layer 200 formed of a composite that includes reinforced fibers and a resin, having a cylindrical shape with a substantially uniform thickness and coupled to the interior surface of the cylindrical pin 100 and a second reinforcement layer 300 formed of a composite that includes reinforced fibers having an elasticity less than the reinforced fibers of the first reinforcement layer 200 and a resin, having a cylindrical shape with a uniform thickness and coupled to the interior surface of the first reinforcement layer 200.

A conventional piston pin is formed of SMC415 steel. Therefore, the conventional piston has a thickness of about 4.3 mm and a weight of about 79 g. The cylindrical pin 100 of the present invention may be formed of steel and in particular, may be formed of SMC415 steel. As will be described, reinforced materials may be coupled to the interior surface of the cylindrical pin 100 and the thickness of the cylindrical pin 100 may be reduced up to about 0.5-1.2 mm.

However, when the thickness of the cylindrical pin 100 is less than about 0.5 mm, flexural strength in a circular arrangement and flexural strength in a length direction may be diminished and thus, the cross-section of the cylindrical pin 100 may be deformed into an oval shape and the minimal thickness of the cylindrical pin 100 may not satisfy the required size tolerance. When the thickness of the cylindrical pin 100 exceeds about 1.2 mm, the hybrid piston pin of the present invention does not exhibit weight reduction effects as compared to the conventional piston pin formed of steel. Therefore, the thickness of the cylindrical pin 100 may be limited within the range of about 0.5-1.2 mm. The cylindrical pin 100 formed of steel may be disposed at the exterior most portion of the hybrid piston pin, may prevent thermal damage and may protect the reinforced materials. The exterior diameter of the cylindrical pin 100 may be within the range of about 7-9 mm.

The first reinforcement layer 200 may be rolled to have a cylindrical shape with a substantially uniform thickness and may be coupled to the interior surface of the cylindrical pin 100. The first reinforcement layer 200 may be formed of a composite that includes reinforced fibers and a resin. In particular, the first reinforcement layer 200 may be formed of a prepreg formed by pre-impregnating fibers with a resin. Thereafter, the second reinforcement layer 300 may be rolled to have a cylindrical shape with a substantially uniform thickness and may be coupled to the interior surface of the first reinforcement layer 200.

In other words, as referenced with respect to the first reinforcement layer 200, the second reinforcement layer 300 may be formed of a composite and may include reinforced fibers and a resin. For example, the second reinforcement layer 300 may be formed of a prepreg by pre-impregnating fibers with a resin. However, the reinforced fibers of the second reinforcement layer 300 may include a reduced elasticity as compared with the reinforced fibers of the first reinforcement layer 200. In particular, elasticity of the reinforced fibers of the second reinforcement layer 300 may be about one third or less that of the reinforced fibers of the first reinforcement layer 200. Therefore, the reinforced fibers that form the first reinforcement layer 200 and the second reinforcement layer 300 may be carbon fibers, the reinforced fibers of the first reinforcement layer 200 may be pitch-based carbon fibers, and the reinforced fibers of the second reinforcement layer 300 may be PAN-based carbon fibers.

Pitch-based carbon fibers, may have an elastic modulus of about 640 GPa or greater and may generally have an increased carbon content and an increased elasticity. Accordingly, the flexural strength and material strength of the hybrid piston pin in the circular arrangement when pitch-based carbon fibers may be coupled to the interior surface of the cylindrical pin 100 formed of steel. For example, the generation of deformation of the cylindrical pin 100 into an oval shape and bending deformation of the cylindrical pin 100 may be suppressed due to an applied load.

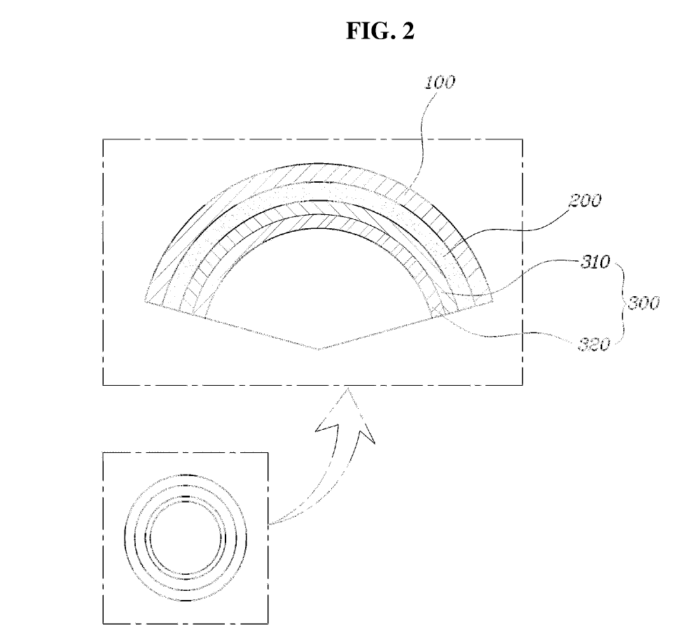

PAN-based carbon fibers, which have an elastic modulus of about 240 GPa or greater, may generally have an increased compressive strength. Further, the PAN-based carbon fibers may support the first reinforcement layer 200 and may withstand load when disposed at the interior most portion of the hybrid piston pin and the flexural strength of the hybrid piston pin in the circular arrangement may be increased. Accordingly, generation of deformation of the cylindrical pin 100 into an oval shape may be suppressed. PAN-based carbon fibers are relatively inexpensive and may reduce the cost. Further, as exemplarily shown in FIG. 2, the second reinforcement layer 300 may include a first composite layer 310 formed of reinforced fibers and a resin and may be disposed in parallel with the length direction of the cylindrical pin 100. Further, a second composite layer 320 formed of reinforced fibers and a resin and may be disposed perpendicular to the length direction of the cylindrical pin 100.

The reinforced fibers of the second reinforcement layer 300 are not limited to being disposed in one direction, for example, the reinforced fibers of the first composite layer 310 coupled to the interior surface of the first reinforcement layer 200 may be disposed in a direction parallel with the cylindrical pin 100 and the reinforced fibers of the second composite layer 320 coupled to the interior surface of the first composite layer 310 may be disposed in a direction perpendicular to the cylindrical pin 100. Accordingly, the stiffness of the hybrid piston pin may be improved and may withstand load applied in the width direction of the hybrid piston pin as well as load applied in the length direction of the hybrid piston pin.

Particularly, the first reinforcement layer 200 and the second reinforcement layer 300 may be integrally molded to increase a coupling degree of the first reinforcement layer 200 and the second reinforcement layer 300. Further, an adhesive film may be coupled to the exterior surface of the first reinforcement layer 200 to couple the first reinforcement layer 200 to the cylindrical pin 100 via the adhesive film. Moreover, when the reinforced fibers of the first reinforcement layer 200 are carbon fibers, potential corrosion may occur due to a potential difference between the carbon fibers and the cylindrical pin 100 formed of steel. The adhesive film may interrupt direct contact between the carbon fibers and the cylindrical pin 100 and may prevent potential corrosion to improve the durability of the hybrid piston pin.

By sequentially attaching the first reinforcement layer 200 formed of carbon fibers having relatively high elasticity and the second reinforcement layer 300 formed of carbon fibers having low elasticity to the interior surface of the cylindrical pin 100, the hybrid piston pin may have a weight of about 25-42 g and may achieve weight reduction by 46% or greater compared to conventional piston pins. Accordingly, when the hybrid piston pin of the present invention is applied to a vehicle, fuel efficiency of the vehicle may be improved by about 0.7-1.2%. Further, the hybrid piston pin of the present invention may have flexural strength in a circular arrangement of 57 MPa or greater and flexural strength in the length direction of 53 MPa and may satisfy desired material properties.

TABLE 1

| | | Flexural | Flexural | Flexural | Flexural |
|---|---|---|---|---|---|
| | | strength in | strength in | modulus in | modulus in |
| | | circular | length | circular | length |
| | Configuration | arrangement | direction | arrangement | direction |
| Test example 1 | Including | 70 MPa | 60 MPa | 109 GPa | 81 GPa |
| | outer pitch- | | | | |
| | based | | | | |
| | reinforcement | | | | |
| | layer and | | | | |
| | inner PAN- | | | | |
| | based | | | | |
| | reinforcement | | | | |
| | layer | | | | |
| Comparative | Including | 55 MPa | 50 MPa | 143 GPa | 54 GPa |
| example 1 | single pitch- | | | | |
| | based | | | | |
| | reinforcement | | | | |
| | layer | | | | |
| Comparative | Including | 170 MPa | 50 MPa | 103 GPa | 36 GPa |
| example 2 | single PAN- | | | | |
| | based | | | | |
| | reinforcement | | | | |
| | layer | | | | |
| Comparative | Including | 55 MPa | 65 MPa | 160 GPa | 106 GPa |
| example 3 | outer PAN- | | | | |
| | based | | | | |
| | reinforcement | | | | |
| | layer and | | | | |
| | inner pitch- | | | | |
| | based | | | | |
| | reinforcement | | | | |
| | layer | | | | |

As shown from above Table 1, a hybrid piston pin in Test example 1 includes a first reinforcement layer 200 formed of pitch-based carbon fibers having relatively high elasticity and a second reinforcement layer 300 formed of PAN-based carbon fibers. The PAN-based carbon fiber has a relatively low elasticity and improved compressive strength and has flexural strength in a circular arrangement and flexural strength in the length direction, which are equal to or greater than those of a piston pin in Comparative example 1 that include a reinforcement layer formed of pitch-based carbon fibers.

Further, the hybrid piston pin in Test example 1 has improved flexural strength in the circular arrangement than a piston pin in Comparative example 2 and includes a reinforcement layer formed of PAN-based carbon fibers. The piston pin in Comparative example 2 has a flexural modulus less than the hybrid piston pin in Test example 1. The hybrid piston pin in Test example 1 has a greater flexural strength in the circular arrangement than a piston pin in Comparative example 3 that includes an exterior reinforcement layer formed of PAN-based carbon fibers and an interior reinforcement layer formed of pitch-based carbon fibers.

TABLE 2

| | Thickness ratio | Thickness ratio | | | | |
|---|---|---|---|---|---|---|
| | of cylindrical | of cylindrical | Flexural | Flexural | Flexural | Flexural |
| | pin to first | pin to second | strength in | strength in | modulus | modulus |
| | reinforcement | reinforcement | circular | length | in circular | in length |
| | layer | layer | arrangement | direction | arrangement | direction |
| Test example | 1:3 | 1:7 | 57 MPa | 74 MPa | 129 GPa | 64 GPa |
| 2 | | | | | | |
| Test example | 1:4 | 1:6 | 65 MPa | 67 MPa | 119 GPa | 73 GPa |
| 3 | | | | | | |
| Test example | 1:5 | 1:5 | 71 MPa | 59 MPa | 109 GPa | 81 GPa |
| 4 | | | | | | |
| Test example | 1:6 | 1:4 | 75 MPa | 53 MPa | 102 GPa | 85 GPa |
| 5 | | | | | | |
| Comparative | 1:2 | 1:7 | 41 MPa | 70 MPa | 131 GPa | 44 GPa |
| example 4 | | | | | | |
| Comparative | 1:7 | 1:4 | 63 MPa | 50 MPa | 122 GPa | 72 GPa |
| example 5 | | | | | | |
| Comparative | 1:6 | 1:3 | 72 MPa | 48 MPa | 102 GPa | 82 GPa |
| example 6 | | | | | | |
| Comparative | 1:3 | 1:8 | 49 MPa | 75 MPa | 136 GPa | 54 GPa |
| example 7 | | | | | | |

As understood from above Table 2, as compared to hybrid piston pins in Text examples 2 to 5, a hybrid piston pin in Comparative example 4 has a thickness ratio of a cylindrical pin 100 to a first reinforcement layer 200 of less than 1:3 and has diminished flexural strength in the circular arrangement. A hybrid piston pin in Comparative example 5 has a thickness ratio of a cylindrical pin 100 to a first reinforcement layer 200 which exceeds a ratio of about 1:6 an has diminished flexural strength in the length direction.

Further, as compared to the hybrid piston pins in Text examples 2 to 5, a hybrid piston pin in Comparative example 6 has a thickness ratio of a cylindrical pin 100 to a second reinforcement layer 300 of less a ratio of about 1:4 and has reduced flexural strength in the length direction. In addition, a hybrid piston pin in Comparative example 7 has a thickness ratio of a cylindrical pin 100 to a second reinforcement layer 300 which exceeds a ratio of about 1:7 and has a reduced flexural strength in the circular arrangement.

A manufacturing method of a hybrid piston pin in accordance with the present invention includes stacking a first prepreg 10 that includes reinforced fibers and a resin and a second prepreg 20 that include reinforced fibers with a reduced elasticity as compared to the reinforced fibers of the first prepreg 10. A resin may be formed by rolling the first prepreg 10 and the second prepreg 20 to form the exterior surface of the first prepreg 10. The rolled first prepreg 10 and second prepreg 20 is integrally molded in an oven. In addition, the molded first prepreg 10 and second prepreg 20 is attached to the interior surface of a cylindrical pin 100 formed of steel.

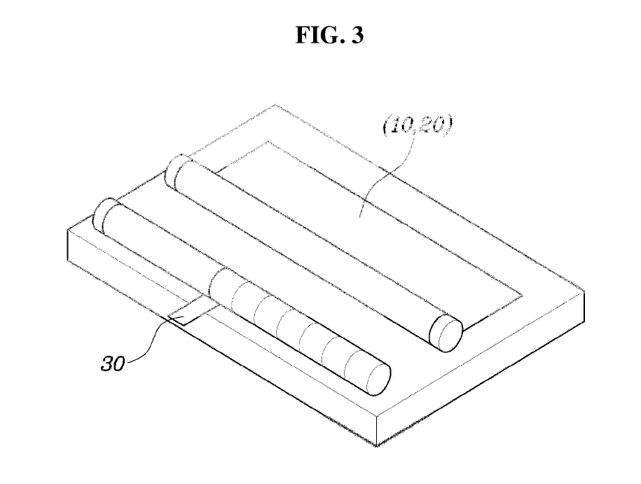

As exemplarily shown in FIG. 3, the first prepreg 10 and the second prepreg 20 may be sequentially stacked in the upward direction and may then be rolled. For example, the stacked first prepreg 10 and second prepreg 20 may be rolled to form the exterior surface of the first prepreg 10 having relatively high elasticity. After rolling, the exterior surface of the rolled first prepreg 10 and second prepreg 20 may be wrapped with a film 30. As the film 30, a heat shrinkable tape having heat resistance may be employed.

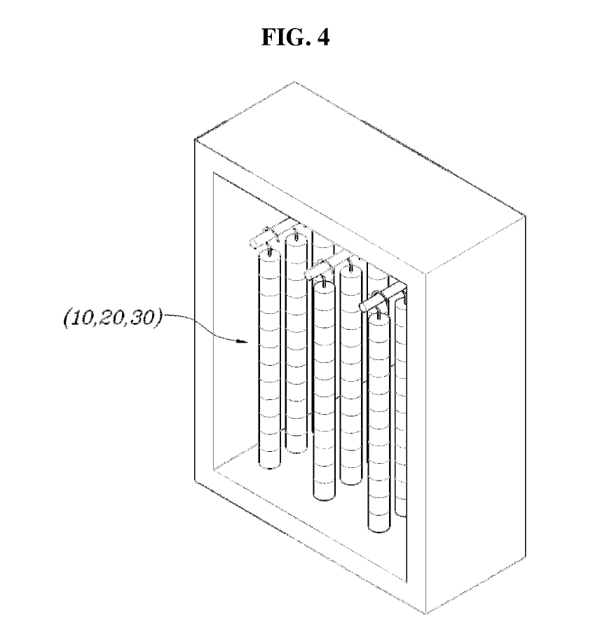

Thereafter, as exemplarily shown in FIG. 4, the first prepreg 10 and second prepreg 20, wrapped with the film 30, may be placed into the oven and may be integrally molded. By wrapping the exterior surface of the rolled first prepreg 10 and second prepreg 20 with the film 30, the film 30 may shrink during heat exposure during molding within the oven and mesopores may be removed from the first prepreg 10 and second prepreg 20. When molding within the oven is completed, the film 30 may be removed and the molded first prepreg 10 and second prepreg 20 may be coupled to the interior surface of the cylindrical pin 100. Then processing may include cutting, surface grinding, etc., may be performed to complete manufacture of the hybrid piston pin.

In stacking, the reinforced fibers of the first prepreg 10 and the second prepreg 20 may be carbon fibers. In particular, the carbon fibers of the first prepreg 10 may be pitch-based carbon fibers, and the carbon fibers of the second prepreg 20 may be PAN-based carbon fibers and elasticity of the first prepreg 10 may be greater than elasticity of the second prepreg 20. Thereafter, the stacked first prepreg 10 and second prepreg 20 may be coupled to the interior surface of the cylindrical pin 100. A thickness ratio of the cylindrical pin 100 to the first prepreg 10 may be about 1:3˜1:6. Further, a thickness ratio of the cylindrical pin 100 to the second prepreg 20 to may be about 1:4˜1:7.

As is apparent from the above description, a hybrid piston pin in accordance with the present invention may be manufactured by sequentially stacking a reinforcement layer that includes reinforced fibers having high elasticity and a reinforcement layer that includes reinforced fibers having relatively low elasticity on the interior surface of a cylindrical pin formed of steel. Accordingly, the flexural strength in a circular arrangement may be increased and flexural strength in a length direction may be increased and a weight reduction by about 47˜67%, as compared to a conventional piston pin formed of steel may be achieved. Further, due to weight reduction, when the hybrid piston pin is applied to a vehicle fuel efficiency of the vehicle may be improved by about 0.7˜1.2% and costs may be reduced reduction.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A hybrid piston pin, comprising:
a cylindrical pin formed of steel;
a first reinforcement layer formed of a composite including reinforced fibers and a resin, having a cylindrical shape with a uniform thickness, and coupled to the interior surface of the cylindrical pin; and
a second reinforcement layer formed of a composite including reinforced fibers, having, elasticity less than the reinforced fibers of the first reinforcement layer, and a resin, having a cylindrical shape with a uniform thickness, and coupled to the interior surface of the first reinforcement layer.

2. The hybrid piston pin according to claim 1, wherein the reinforced fibers of the first reinforcement layer and the second reinforcement layer are carbon fibers, wherein the reinforced fibers of the first reinforcement layer are pitch-based carbon fibers, and the reinforced fibers of the second reinforcement layer are PAN-based carbon fibers.

3. The hybrid piston pin according to claim 1, wherein a thickness ratio of the cylindrical pin to the first reinforcement layer is about 1:3-1:6.

4. The hybrid piston pin according to claim 3, wherein a thickness ratio of the cylindrical pin to the second reinforcement layer is about 1:4-1:7.

5. The hybrid piston pin according to claim 1, wherein the second reinforcement layer includes:
a first composite layer formed of reinforced fibers and a resin and disposed parallel to the length direction of the cylindrical pin; and
a second composite layer formed of reinforced fibers and a resin and disposed perpendicular to the length direction of the cylindrical pin.

6. The hybrid piston pin according to claim 1, further comprising: an adhesive film disposed between the cylindrical pin and the first reinforcement layer to couple the first reinforcement layer to the cylindrical pin.

7. A manufacturing method of a hybrid piston pin, comprising:
stacking a first prepreg including reinforced fibers and a resin and a second prepreg including reinforced fibers, having elasticity less than the reinforced fibers of the first prepreg, and a resin;
rolling the first prepreg and the second prepreg to form an exterior surface from the first prepreg;
integrally molding the rolled first prepreg and second prepreg in an oven; and
attaching the molded first prepreg and second prepreg to the interior surface of a cylindrical pin formed of steel.

8. The manufacturing method according to claim 7, wherein, in stacking of the first prepreg and the second prepreg, the reinforced fibers of the first prepreg and the second prepreg are carbon fibers, wherein the reinforced fibers of the first prepreg are pitch-based carbon fibers, and the reinforced fibers of the second prepreg are PAN-based carbon fibers.

9. The manufacturing method according to claim 8, wherein a thickness ratio of the cylindrical pin to the first prepreg is about 1:3˜1:6, and a thickness ratio of the cylindrical pin to the second prepreg is about 1:4˜1:7.

10. The manufacturing method according to claim 7, further comprising: wrapping the exterior surface of the rolled first prepreg and second prepreg with an anti-resistant film, after rolling.
